(19) United States
(12) Patent Application Publication
(10) Pub. No.: US 2026/0067843 A1
(43) Pub. Date: Mar. 5, 2026

(54) METHODS FOR PERFORMING A REGISTRATION PROCEDURE FOR CONNECTING A USER EQUIPMENT TO A CELLULAR MOBILE COMMUNICATION SYSTEM, USER EQUIPMENT, GATEWAY AND CELLULAR MOBILE COMMUNICATION SYSTEM

(71) Applicant: NEC Laboratories Europe GmbH, Heidelberg (DE)

(72) Inventors: Lanfranco ZANZI, Heidelberg (DE); Marco LIEBSCH, Heidelberg (DE)

(21) Appl. No.: 19/107,060

(22) PCT Filed: Mar. 22, 2024
(86) PCT No.: PCT/EP2024/057826

§ 371 Date: Feb. 27, 2025

(30) Foreign Application Priority Data
Mar. 22, 2023 (EP) 23163525.1

(51) Int. Cl. H04W 60/04; H04W 74/0816; H04W 76/20

(52) U.S. Cl. CPC H04W 60/04; H04W 74/0816; H04W 76/20

(57) ABSTRACT

A method is performed by a user equipment. The method includes providing, to an entity of a cellular mobile communication system, a request for registering the user equipment to the cellular mobile communication system, via a non-cellular communication channel; and performing a registration procedure for connecting the user equipment to the cellular mobile communication system, based on the request.

### CROSS REFERENCE TO RELATED APPLICATIONS

This application is a U.S. National Phase application under 35 U.S.C. § 371 of International Application No. PCT/EP2024/057826, filed on Mar. 22, 2024, and claims benefit to European Patent Application No. 23163525.1, filed on Mar. 22, 2023. The International Application was published in English on Sep. 26, 2024 as WO 2024/194476 A1 under PCT Article 21(2).

### FIELD

The present disclosure relates to a method for a user equipment, to a method for a gateway of a cellular mobile communication system, to a user equipment, to a gateway, and to a cellular mobile communication system.

### BACKGROUND

Mobile User Equipment (UE) following the 5^{th} Generation of Mobile Communication (5G) connect to the cellular network infrastructure through a registration procedure. The first phase of the procedure comprises cell search and selection, for which the UE needs to scan frequencies, synchronize with a cellular base station (gNodeB, gNB) and retrieve system information from the gNBs broadcast channels.

The UE initiates the registration procedure after having selected a suitable cell. The UE makes use of the cell's shared channels to initiate a series of Signal Radio Bearer related steps for Radio Resources Control (RRC). After a successful exchange of a series of RRC messages, the RRC Setup Complete message may embed (piggyback) the first message of the subsequent procedure, which the UE sends towards the core network's Access and Mobility Management Function (AMF): the Non-Access Stratum (NAS) Registration procedure. According to the standard's procedure, the NAS procedure can be performed through a synchronized gNB only after successful completion of the RRC procedure.

In crowded environments (such as in a stadium, or in case of an emergency/disaster) where many UEs perform the registration procedure concurrently, the RRC procedure of a set of UE may fail on first attempt, since the selected cell's shared channel is overloaded as too many UEs try to access the medium concurrently. This results in a stalled access procedure for various UEs, so that the NAS procedure needs to be deferred. Deferred access to the infrastructure and completion of connection setup is not desirable, in particular for a certain group of UEs, for example a group operating mission-critical services.

### SUMMARY

In an embodiment, the present disclosure provides a method performed by a user equipment. The method includes providing, to an entity of a cellular mobile communication system, a request for registering the user equipment to the cellular mobile communication system, via a non-cellular communication channel; and performing a registration procedure for connecting the user equipment to the cellular mobile communication system, based on the request.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1-1 and 1-2 show a flow chart of a registration procedure according to a 3GPP standard;

FIG. 2a shows a flow chart of a four-step random access channel procedure according to an embodiment of the present disclosure;

FIG. 2b shows a flow chart of a two-step random access channel procedure according to an embodiment of the present disclosure;

FIG. 3 shows a schematic diagram of a cellular and non-cellular inter-working architecture according to an embodiment of the present disclosure;

FIG. 4 shows a schematic diagram of an example of a proposed workflow according to an embodiment of the present disclosure;

FIG. 5 shows a flow chart of an example of a method for a user equipment according to an embodiment of the present disclosure;

FIG. 6 shows a flow chart of an example of a method that is primarily being performed by a gateway of a cellular mobile communication system according to an embodiment of the present disclosure;

FIGS. 7a-1 and 7a-2 show a flow chart of a first more detailed example of the proposed workflow according to an embodiment of the present disclosure; and

FIGS. 7b-1 and 7b-2 show a flow chart of a second more detailed example of the proposed workflow according to an embodiment of the present disclosure.

### DETAILED DESCRIPTION

Embodiments of the present disclosure can improve and further develop a method for performing a registration procedure for connecting a user equipment to a cellular mobile communication system, which overcomes the aforementioned drawbacks.

Embodiments of the present disclosure are based on the finding that UEs often are not limited to one channel of communication. For example, smartphones, which are one example of a UE, have communication interfaces for communicating via Wifi, Bluetooth, UltraWideBand (UWB) etc. in addition to their communication interface for communicating via a cellular mobile communication system such as 5G. Moreover, modern cellular mobile communication systems, such as 5G cellular mobile communication systems, have a gateway that allow a UE to communicate with the core network of the cellular mobile communication system, without having to use a base station of the cellular mobile communication system, e.g., to place a call in areas with insufficient cellular coverage. In embodiments of the present disclosure, these two capabilities of the UE on one side, and of the cellular mobile communication system on the other side, are leveraged to enable the UE to perform the registration procedure without using the cell's random access-based shared channel for the registration procedure. This way, the UE can perform the registration procedure without risking failure or delay due to contention of the shared channel being used to initiate the registration procedure, which reduces contention of the shared channel and avoids the risk of delays caused by unsuccessful attempts to communicate via the shared channel.

For example, embodiments of the present disclosure may leverage the 5G system's architecture to access the core network through non-3GPP (3rd Generation Partnership Project, a standardization organization for standardizing cellular mobile communication networks) access (i.e., a non-cellular communication channel), which has been primarily been specified to set up connections through non-3GPP access technologies, such as WiFi, while sharing the same control-and data plane nodes that are developed for 3GPP access. Connections through non-3GPP access are typically used in addition to 3GPP access connections, for example for load balancing, increased coverage for indoor/outdoor scenarios, and bandwidth aggregation. Embodiments of the present disclosure use non-3GPP access as ‘backdoor’ access in case the RRC procedure cannot be performed due to an overloaded shared channel of the selected cell, with the intention to advance and complete the NAS procedure while the UE contends for the shared medium on the selected 3GPP cell to complete the RRC procedure. The method according to embodiments of the present disclosure may be used to accelerate UEs' access and completion of the 3GPP registration procedure.

A first aspect of the present disclosure relates to method performed by a user equipment. The method comprises providing, to an entity of a cellular mobile communication system, a request for registering the user equipment to the cellular mobile communication system via a non-cellular communication channel. The method comprises performing a registration procedure based on the request. By transmitting the request via the non-cellular communication channel, a potential delay in the registration procedure caused by contention on the cell's shared channel can be avoided, as registration, authorization and authentication can be performed in parallel. Thus, completion of the registration procedure can be accelerated.

For example, the request may be provided via the non-cellular communication channel instead of providing the request via a cellular communication channel between the user equipment and a cellular base station, e.g., after the cellular communication channel has been established based on a random access procedure to a shared channel of the cellular mobile communication system. This way, failure of performing the initial registration procedure via random access has less impact on the time to complete registration.

In particular embodiments, the request may be provided via the non-cellular communication channel after an unsuccessful attempt of gaining access to a shared channel of the cellular mobile communication system. Thus, instead of incurring the additional delay of the backoff procedure specified in the 3GPP standard, the present approach can be used to accelerate the registration procedure.

In some examples, the request may be provided to a gateway of the cellular mobile communication system for providing access to a core network of the cellular mobile communication system via non-cellular communication channels. For example, this may be the same gateway being used for WiFi calling and/or load balancing purpose. This way, no additional entity of the cellular mobile communication system may be necessary for implementing the proposed approach.

In many cases, UEs also include WiFi radios in addition to their cellular radios. Accordingly, the request may be provided via a wireless communication channel being based on a communication protocol of the group of IEEE (Institute of Electrical and Electronics Engineers) 802.11-based communication protocols (i.e., WiFi).

For example, the request may include a Non-Access Stratum, NAS, registration message. The NAS registration message is, in conventional systems, the first message that is part of the registration request after the Random Access Channel portion of the registration is completed. As the Random Access Channel portion of the registration is not necessary in the present case, the registration procedure can start with the NAS registration message.

Once registration has been triggered by the UE, it is being processed by the entities of the cellular mobile communication system. To initiate the connection with the base station (via a cellular channel), these entities may provide the UE with helpful information, such as an identifier of the base station that the UE is to connect to, RRC and RACH parameters, uplink/downlink synchronization information etc., which speeds up the connection procedure at the target base station. Thus, the method may comprise obtaining, by the user equipment and from the entity of the cellular mobile communication system via the non-cellular communication channel, information on the user equipment being registered to the cellular mobile communication system. The information on the user equipment being registered to the cellular mobile communication system may comprise at least one of information on a target base station the user equipment is to be connected to, Random Access Channel, RACH, parameter information, Radio Resource Control, RRC, parameter information, uplink/downlink synchronization information, and a Cell-Random Temporary Network Identifier, C-RTNI. The method may comprise connecting to the target base station based on the information on the user equipment being registered to the cellular mobile communication system. This may facilitate and thus speed up the subsequent connection of the UE to the target base station.

A second aspect of the present disclosure relates to a user equipment being configured to perform the above method.

A third aspect of the present disclosure relates to a method performed by a gateway of a cellular mobile communication system. The method comprises obtaining a request for registering a user equipment to the cellular mobile communication system. The request has initially been transmitted by the user equipment via a non-cellular communication channel. The method comprises forwarding the request to an entity of a core network of the cellular mobile communication system. By using the gateway, instead of the base station, to obtain and forward the request to the core network, waiting for successful access to the shared channel via random access can be avoided for the purpose of transmitting the registration request-in effect, the authentication and authorization procedure with the can be performed in parallel without need to wait for the end of the RACH procedure. Once the user equipment successfully performs the random access procedure, synchronization with the cellular access base station can be completed.

Logically, the request may be forwarded to the entity of the core network on behalf of a target base station the user equipment is to be connected to. In other words, the gateway takes the place of the target base station for the purpose of forwarding the request to the core network, to avoid failure in communicating on the shared channel.

Some aspects of the method may be performed by entities other than then gateway. For example, first information on the user equipment being registered to the cellular mobile communication system may be provided from the entity of the core network node of the cellular mobile communication system to a target base station which the user equipment is to be connected. A user equipment context for the user equipment may be set up by the target base station. The first information on the user equipment being registered to the cellular mobile communication system is used to make the target base station aware that the user equipment intends to connect to the target base station, thus facilitating and accelerating the connection procedure at the target base station.

In addition to the UE, suitable information may also be provided to the UE. For example, the method may comprise receiving, by the gateway and from the entity of the core network of the cellular mobile communication system, second information on the user equipment being registered to the cellular mobile communication system. The method may comprise forwarding the second information on the user equipment being registered to the cellular mobile communication system to the user equipment via the non-cellular communication channel. This information may be used to speed up the subsequent connection of the UE to the target base station.

For example, the second information on the user equipment being registered to the cellular mobile communication system may comprise information on a target base station the user equipment is to be connected to. This way, the user equipment can be made aware of which base station expects the incoming connection by the user equipment.

For example, the second information on the user equipment being registered to the cellular mobile communication system may comprise at least one of Random Access Channel, RACH, parameter information, Radio Resource Control, RRC, parameter information, uplink/downlink synchronization information, and a Cell-Random Temporary Network Identifier, C-RTNI. This information can be used to forego major parts of the conventional registration procedure, thus accelerating the registration procedure.

The decision, which base station the UE is to connect to can be made by different entities. For example, a target base station the user equipment is to be connected to may be selected by one of the gateway and the entity of the core network of the cellular mobile communication system based on the request.

A fourth aspect of the present disclosure relates to a gateway being configured to perform aspects of the above method being ascribed to the gateway.

A fifth aspect of the present disclosure relates to a cellular mobile communication system comprising a gateway and a core network with at least one core network entity, being configured to perform the above method for the cellular mobile communication system.

Examples of the present disclosure relate to methods, to a UE and to a system for cellular access (e.g., cellular access according to a 3GPP cellular mobile communication standard) access congestion impact mitigation by using a non-cellular (e.g., 3GPP cellular mobile communication standard) fallback procedure. In particular embodiments, the present disclosure provides methods, a UE and a system to perform a registration and access procedure to setup a communication data plane in cellular mobile communication systems (e.g., 3GPP networks) through non-cellular (e.g., non-3GPP) networks.

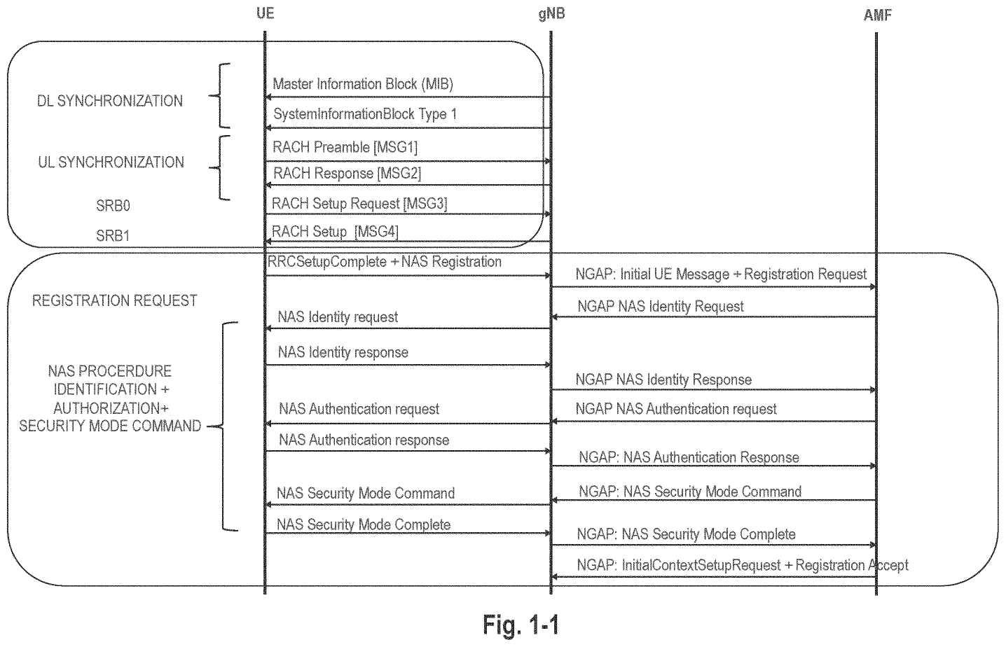

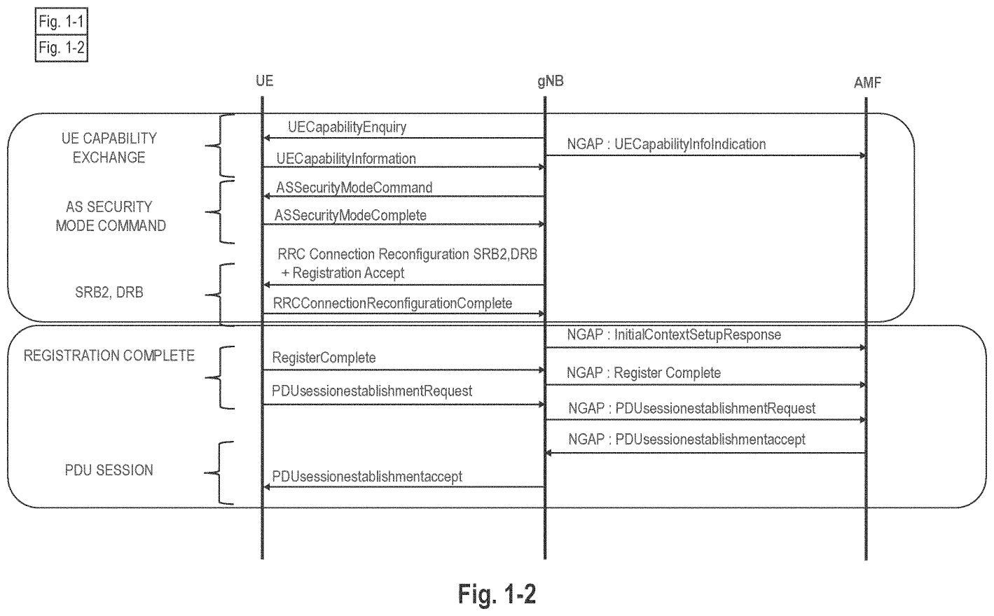

In the following, some context is provided on topics and procedures related to the proposed concept in the context of 3GPP and Non-3GPP network convergence. A 3GPP standard registration procedure is illustrated in FIG. 1 for reference.

First, some background on 5G Cell discovery and the RACH (Random Access Channel) procedure is provided.

In a first operation, the UE first looks for a primary synchronization signal (PSS) which is transmitted in the last OFDM (Orthogonal Frequency Division Multiplexing) symbol of the first time slot of the first subframe (subframe 0) in a radio frame. This enables the UE to acquire the slot boundary independently from the chosen cyclic prefix selected for this cell.

In a second operation, the UE obtains the radio frame timing and the cells' group identity. This information can be found from the secondary synchronization signal (SSS). In the time domain, the SSS is transmitted in the symbol before the PSS. The SSS also has a 5 ms periodicity, which means it is transmitted in the first and sixth subframes (subframes 0 and 5).

In a third operation, after successful execution of the cell-search procedure described in the previous section, the device (UE) is able to decode the Physical Broadcast Channel (PBCH) and read out the Master Information Block (MIB). The periodicity is 40 ms. System information in LTE is separated into the MIB and a number of System Information Blocks (SIBs). MIB is transmitted according to a fixed cycles (every 4 frames starting from SFN 0). SIB1 is also transmitted according to a fixed cycle (every 8 frames starting from SFN 0). SIB 1 contains important information such as: Cell access-related information (such as Public Land Mobile Network (PLMN) Identity List, PLMN Identity, TA (Timing Advance) Code, cell identity & cell status), cell Selection Information (such as a minimum receiver level) and/or scheduling information (such as Scheduling Information (SI) message type & periodicity, SIB mapping info, SI window length).

Next, some background on the Random Access Channel (RACH) procedure is given. As described in Technical Specification TS23.502 (“5G Procedures for the 5G System Release 15), in 3GPP cellular networks (LTE/5G) UEs perform a Random Access CHannel (RACH) procedure to connect to the base station (eNodeB in LTE, gNodeB in 5G) and establish the data channel communication.

The LTE standard defines two random access procedures: a contention-based and a contention-free. The access procedure begins with the UE sending a message on the Physical RACH (PRACH). 5G New Radio inherits the same procedure.

During the contention-based procedure, the UE randomly selects one of the 64 N_{cf} orthogonal preamble signatures and the next available subframe for PRACH transmission, where N_{cf} is the number of preamble signatures allocated for the contention free procedure (its value can change according to traffic load in the system). After sending the attachment request, the UE monitors the physical downlink control channel (PDCCH) and schedules a timer. In case of simultaneous RACH requests, the eNB uses the preamble sequence to differentiate among users.

However, particularly in crowded areas, different requests may collide. In this case, the eNB is not able to decode the requests, thereby triggering an exponential backoff procedure in the UE, which delays the next access attempt. If no other user selects the same preamble sequence, the eNB is able to decode the request and replies with a Random-Access Response (RAR) message through the PDCCH. At this point, the UE sends a RRC connection request message including a temporary identifier and the establishment cause. If accepted by the network, the access procedure terminates, and the UE moves into the RRC_CONNECTED state so that it is allowed to use the data communication services of the system.

Several improvements can be adopted to increase the performance of the RACH procedure. Typical deployments assume collision probability between UEs in the order of 1% with periodic random-access occasions distributed every 10 ms. This setup translates into the possibility to handle an offered load of 128 attempts/second over 10 MHz bandwidth (S. Sesia, I. Toufik, and M. Baker, LTE, The UMTS Long Term Evolution: From Theory to Practice. Wiley Publishing, 2009). Clearly, such a setup leads to low performance when dealing with crowded events. Typical approaches to solve this situation involve the reduction of the access occasion cycle duration and the increase of access opportunities within one frame, however this negatively impacts the PRACH overhead finally reducing the scheduling opportunities for user data transmissions.

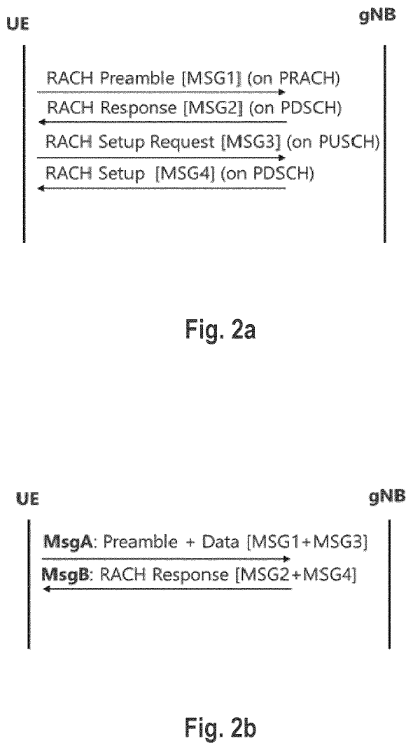

FIG. 2a shows a flow chart of a four-step random access channel procedure.

In a first operation, the UE transmits the random access preamble to the base station (BS). The UE selects one of the available PSs (Preamble Signatures) and transmits it in a time-frequency slot. Several UEs may choose the same PS and the BS may not be able to decode it. After the PS transmission, the UE begins to monitor the downlink control channel (PDCCH) looking for an answer.

In a second operation, the UE receives/waits for the random access response (RAR). BS replies on the PDCCH with an ID identifying the time-frequency slot in which the PS was decoded. If no RAR matching message is received, the UE starts a backoff procedure. The duration of such backoff is randomly chosen in the range (0, 960 ms].

In a third operation, the UE that receives the RAR message responds with a scheduled transmission request (to the BS) that includes the ID of the device and a radio resource control (RRC) connection request message on the uplink shared channel (UL-SCH).

In a fourth operation, contention resolution is released by the BS to the UE on the PDSCH. This identifies that no conflict on the access procedure exists. The UE can transfer data to BS.

3GPP specifications introduced for Release 16 specify a novel two-step RACH (2SR) procedure. FIG. 2b shows a flow chart of the two-step random access channel procedure. This new procedure not only reduces the latency but also the control-signaling overhead due to the reduced number of messages transmitted. As depicted in FIG. 2a and the messages in time order in the 4-step RACH (4SR) procedure are named as Msg1, Msg2, Msg3, Msg4. While in the 2SR, the messages are named as MsgA and MsgB.

More specifically, the channel structure of MsgA comprises preamble (Msg1) and data part (Msg3) in the physical uplink shared channel (PUSCH) and, MsgB combines the random-access response (Msg2) and the contention resolution (Msg4). Consequently, there is only one round-trip cycle between the user equipment (UE) and the base station (gNB) to complete the 2SR procedure instead of the two round-trip cycles required in 4SR, as detailed in M. Enescu et al., “5G New Radio A Beam-Based Air Interface,” Wiley, 2020.

Despite the reduced number of messages exchanged during the registration procedure, a trade-off still exists between the collision probability of the PUSCH part of MsgA and the resource overhead for 2SR.

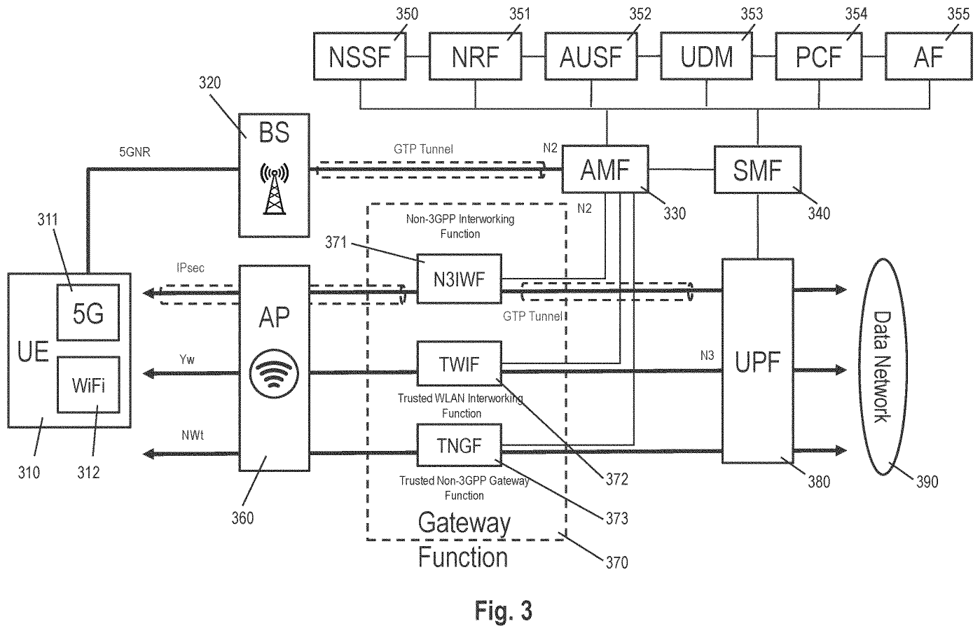

Next, some background on non-3GPP access in 5G is given with reference to FIG. 3. N3IWF 371-Non-3GPP Inter Working Function acts as a gateway for the 5GCN (5G Core Network) with support for N2 and N3 interface towards the 5GCN. It provides a secure connection for the UE 310 accessing the 5GCN over non-3GPP access network 360 with support for IPsec (Internet Protocol security, a group of protocols for establishing secure tunnels) between the UE and the N3IWF.

A UE accessing the 5GCN through an untrusted WLAN 360 (Wireless Local Area Network, e.g., a local, non-cellular wireless network according to a protocol of the group of IEEE 802.11 wireless communication protocols) may support NAS (Non-Access Stratum) signaling and may initially register and authenticate with the 5GCN using the N3IWF. The AMF (Access and Mobility Management Function) 330 is used to register the UE and the AUSF (Authentication Service Function) 352 is used to authenticate the UE using EAP-AKA (Extensible Authentication Protocol-Authentication and Key Agreement)/5G-AKA authentication.

Before the end of registration procedure, an IPsec Security Association (SA) is setup between the UE and N3IWF for securing the NAS mobility and session management messages.

The transfer of UL and DL data packets between the UE and data network uses the secure IPsec tunnel(s) between UE and N3IWF and the GTPU (General Packet Radio Service Tunnelling Protocol) tunnel between N3IWF and UPF (User Plane Function) 380.

In these settings, two separate and parallel PDU (Protocol Data Unit) sessions are active, having a common anchor/end point at the UPF. The UPF can perform traffic steering operations influencing which Radio Access Technology (RAT) will be adopted by the UE. This kind of setup can also make use of advanced transport protocols like Multi-Path TCP (Transmission Control Protocol) to concurrently exploit the two PDU sessions and RAT (Radio Access Technology). The reference architecture is depicted in FIG. 3. FIG. 3 shows a schematic diagram of a cellular and non-cellular inter-working architecture.

In such a cellular and non-cellular inter-working architecture, the UE 310 has two communication transceivers, e.g., a 5G transceiver 311 and a WiFi transceiver 312. The 5G transceiver 311 is used to connect to BS 320, e.g., using a 5G New Radio (5GNR) cell provided by the BS 320. The BS 320 uses a GTPU tunnel to communicate with AMF 330 via the N2 interface. The AMF is part of the core network (CN) of the 5G cellular mobile communication system, and connects to the SMF (Session Management Function) 340, NSSF (Network Slice Selection Function) 350, NRF (NF Repository Function) 351, AUSF 352, UDM (Unified Data Management) 353, PCF (Policy Control Function) 354 and AF (Application Function) 355. The SMF 340 connects to UPF 380. UE 310 further communicates via WiFi Access Point (AP) 360 with the GWF (Gateway Function) 370, the GWF 370 comprising the N3IWF 371, TWIF (Trusted WLAN Interworking Function) 372 and TNGF (Trusted Non-3GPP Gateway Function) 373. In particular, the UE 310 uses an IPSec tunnel to connect to N3IWF 371 via AP 360, and N3IWF 371 uses a GPTU tunnel to connect to UPF 380. Additional channels Yt and NWt are established between UE and TWIF/TNGF, respectively. In the following of the document, it will be referred to Gateway Function (GWF) to refer to N3IWF, TWIF, TNGF entities as the proposed approach can be easily extended to account for all the above scenarios.

Embodiments of the present disclosure provide methods and systems to exploit a non-cellular (e.g., non-3GPP) network as fallback option to establish a radio link communication towards a cellular (e.g., 3GPP 5G) network.

As explained in the previous section, 5G NR inherits from LTE (Long Term Evolution, the 4^{th} generation set of 3GPP cellular mobile communication system protocols) the RACH procedure to let UEs access the shared radio medium. While this procedure guarantees fairness among UEs accessing the radio spectrum mainly due to probabilistic and randomized procedures, it also brings unpredictable performances in terms of access latency. This is especially true when in presence of a large number of UEs concurrently trying to register with the network, and a small number of mobile network base stations, like e.g., in crowded events hosted in stadium premises. In these scenarios in fact, the probability of RACH preamble collision increases significantly, finally causing UEs to perform a randomized backoff.

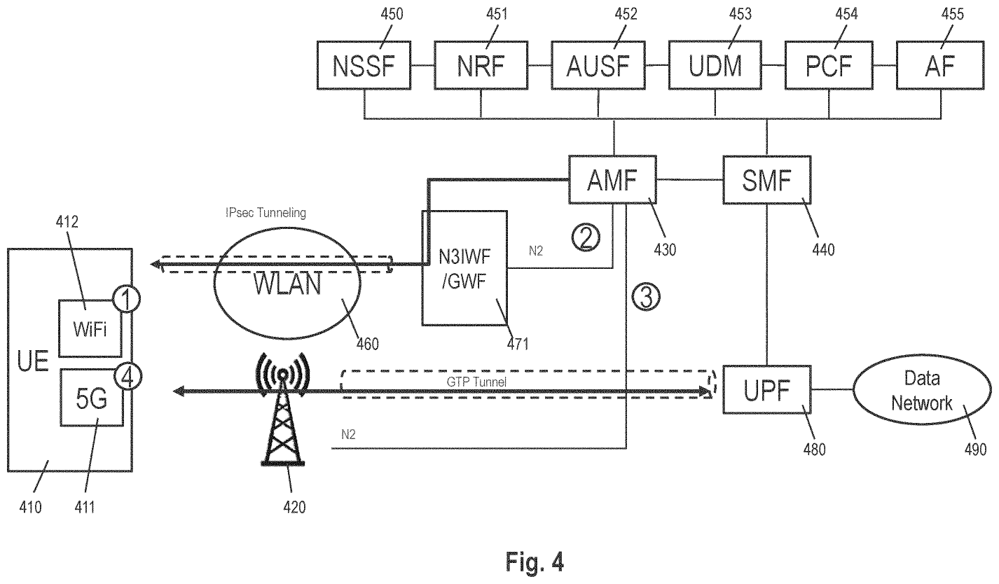

Therefore, to alleviate this issue and more in general to enable a new registration option in the context of Non3GPP/3GPP convergence, embodiments of the present disclosure propose the following procedure as depicted in FIG. 4.

FIG. 4 shows a schematic diagram of an example of a proposed workflow. In FIG. 4, the same entities as in FIG. 3 are shown, with the reference numerals being incremented by 100. However, some of the entities (UE 410, N3IWF/GWF 471 and AMF 430) gain new functionality. Note that presence of a GWF function 471 with an already established connectivity with the mobile core (through the N2 end-point), as well as the UE 410 connected to a nearby Non-3GPP access point 460 is assumed.

In the proposed workflow, at (1), the UE 410 starts its registration procedure by sending a NAS registration message to the core network. It may exploit any Non-3GPP access point 460 available in the area. At (2), the request reaches the GWF function 471, which forwards it on behalf of the target gNB 420, to the 5G core network and its AMF function 430. This operation assumes changes to the standard procedure, which will be addressed in detail in the following. At (3), upon successful NAS registration, authentication and authorization, the AMF 430 may inform the target gNB 420 about the outcome of the overall procedure initiated over the Non-3GPP domain. The gNB 420 sets up a dedicated UE context at RRC (Radio Resource Control) level. The AMF may also inform the GWF 471 about the outcome of the overall procedure, which is forwarded to the requesting UE 410. This message may include auxiliary information, like e.g., the target gNB selected by the network for load balancing reasons. At (4), the UE 410 proceeds with DL/UL (Downlink/Uplink) synchronization operations, exploiting the information normally broadcast by the base station. A dedicated PDU session can now be established to enable 5G data plane connectivity.

By means of this proposed procedure, the requesting UE may benefit from a faster registration, given that NAS registration, authentication and authorization procedure are performed independently of the success of the RACH procedure. More importantly, the UE may not need to go through the potentially conflicting RACH scenarios.

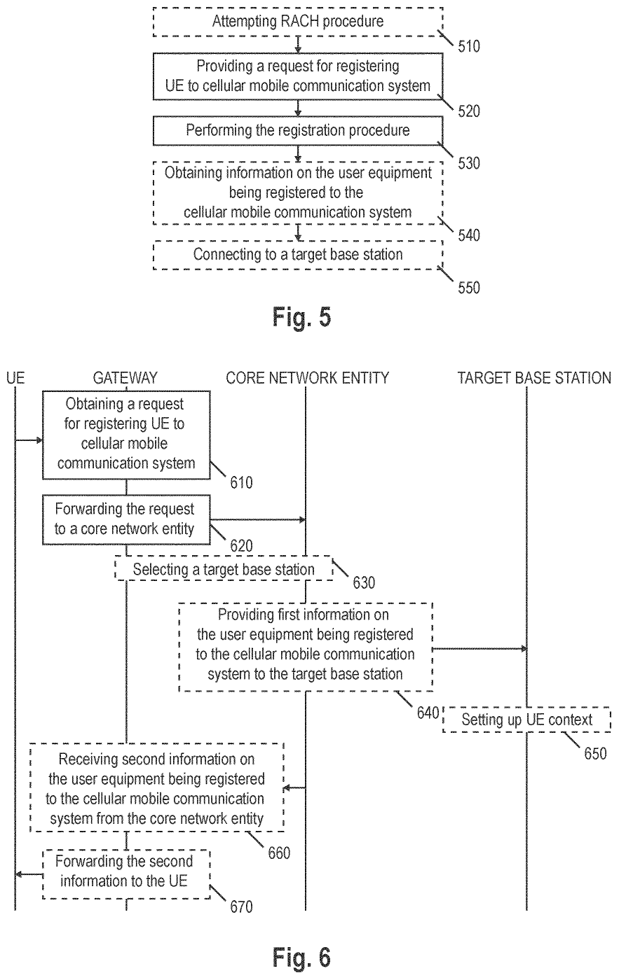

It is evident that some aspects of the proposed workflow are being performed by the UE 410, while some other aspects of the proposed workflow are being performed by the cellular mobile communication system (420-455, 470-480). Therefore, in the following, two separate methods are presented, one for the UE (FIG. 5) and one for the gateway, and in some cases other entities, of the cellular mobile communication system (FIG. 6). In some cases, both methods may be combined into one overarching method covering both the UE and the respective components of the cellular mobile communication system, e.g., the UE and the gateway, or the UE, the gateway, and a core network entity (and further optionally a target base station).

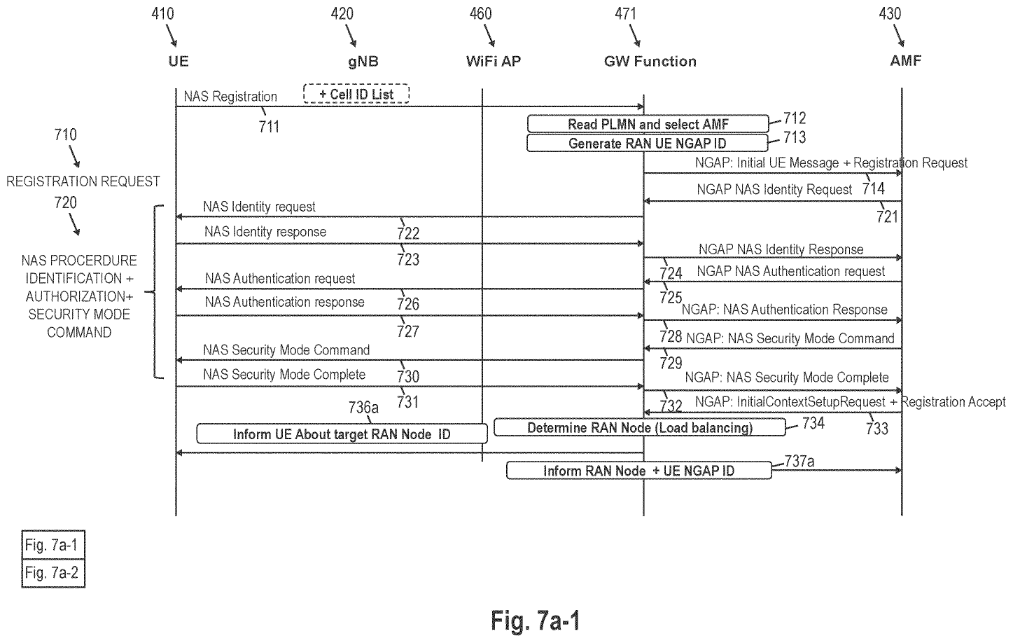

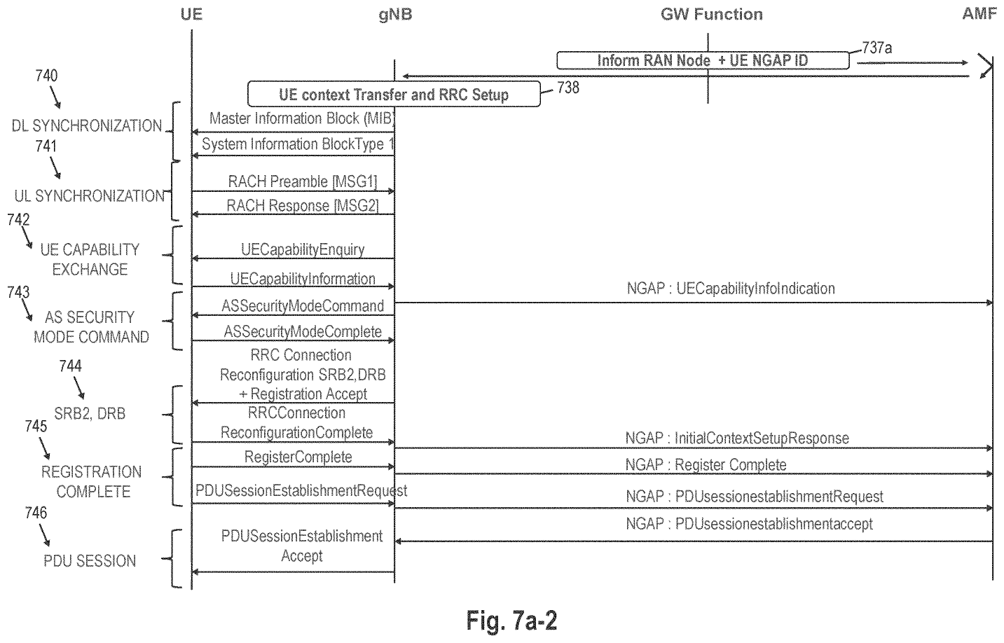

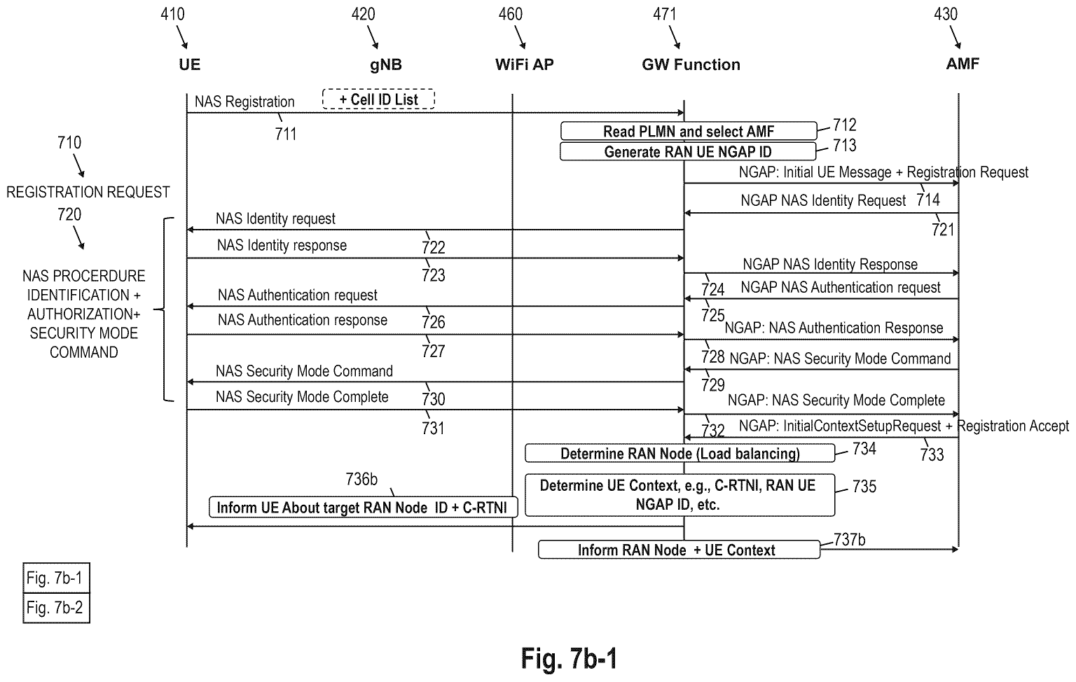

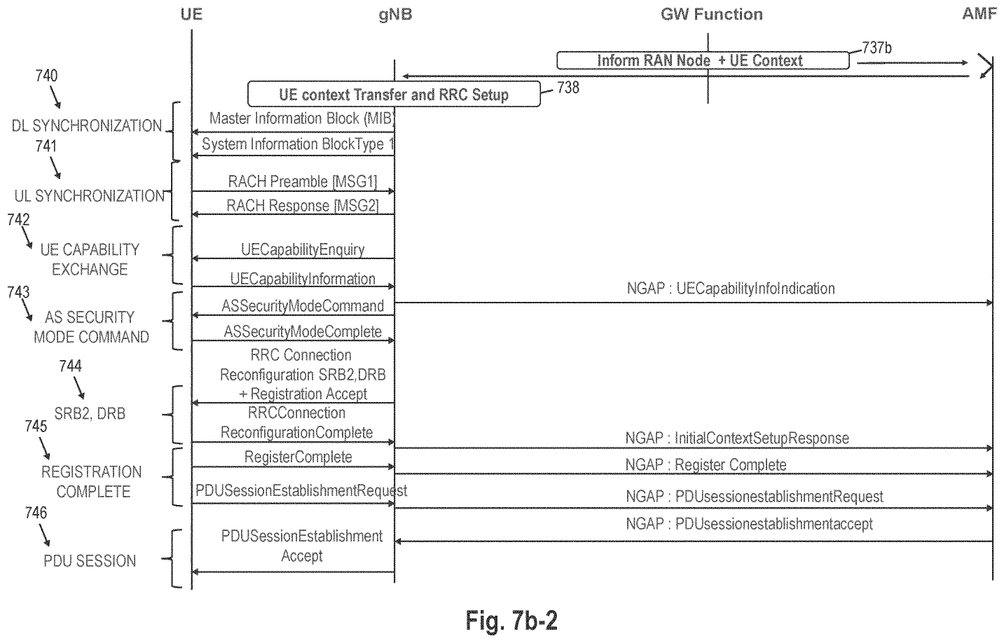

FIG. 5 shows a flow chart of an example of a method being performed by a user equipment. The method may be for performing a registration procedure for connecting a user equipment to a cellular mobile communication system. The method comprises providing 520, by the user equipment (e.g., UE 410), a request for registering the user equipment to the cellular mobile communication system (e.g., the 5G cellular mobile communication system), which may comprise or correspond to NAS registration message 711 of FIG. 7a or 7b, to an entity of the cellular mobile communication system. For example, the request may be provided to a gateway of the cellular mobile communication system for providing access to a core network of the cellular mobile communication system via non-cellular communication channels, such as the GWF/N3IWF 471).

The request is provided by the user equipment via a non-cellular communication channel 460. For example, the non-cellular communication channel is a communication channel that is being accessed by user equipment directly, and that is not provided according by a cellular base station (e.g., a base station, such as an eNodeB or gNodeB as defined by the 3GPP), but according to a non-cellular access point, such as a WiFi access point. In the present context, “non-cellular communication channel” is a communication channel that is not provided by a cellular base station. For example, in the example of FIG. 4, the request is provided via a wireless communication channel being based on a communication protocol of the group of IEEE 802.11-based communication protocols, i.e., via WiFi/WLAN.

In general, the request for registering the user equipment to the cellular mobile communication system is provided via the non-cellular communication channel instead of providing the request via a cellular communication channel between the user equipment and a cellular base station, e.g., categorically (i.e., without previous congestion of the random access to the shared channel, i.e., the RACH procedure) or after an unsuccessful attempt 510 of gaining access to a shared channel of the cellular mobile communication system. The method comprises performing 530 the registration procedure based on the request for registering the user equipment to the cellular mobile communication system being transmitted via the non-cellular communication channel. For example, the registration procedure may be performed 530 via the non-cellular communication channel, and may include various messages exchanges conventionally performed via the cellular communication channel, such as NAS Identification, Authentication and Security Mode. The method may further comprise connecting 550, by the user equipment, to a base station of the cellular mobile communication system, based on the registration.

For example, the method of FIG. 5 may be performed by a user equipment (UE) that is capable of communicating via a cellular communication channel (e.g., a 3GPP-based cellular communication channel) and of communicating via a (wireless) non-cellular communication channel (e.g., WiFi). Accordingly, the user equipment may comprise a first transceiver for communicating via a cellular communication channel and a (separate) second transceiver for communicating via a non-cellular communication channel. The user equipment may comprise processor circuitry to control the first and second transceiver.

FIG. 6 shows a flow chart of an example of a method that is primarily being performed by the gateway of the cellular mobile communication system. The method comprises obtaining 610, by the gateway of the cellular mobile communication system (e.g., to the GWF/N3IWF 471), a request for attaching a user equipment to the cellular mobile communication system. The request has initially been transmitted by the user equipment (e.g., UE 410) via a non-cellular communication channel (e.g., WiFi connection 460). The method comprises forwarding 620, by the gateway, the request for registering the user equipment to the cellular mobile communication system to an entity of a core network (e.g., to AMF 430) of the cellular mobile communication system. As a result, the request for registering the user equipment to the cellular mobile communication system is forwarded, by the gateway, to the entity of the core network on behalf of a target base station the user equipment is to be connected to.

The general concept outlined in connection with FIGS. 4, 5 and 6 will now be covered in more detail in connection with two examples shown in FIGS. 7a and 7b. While FIGS. 7a and 7b show comprehensive flow charts, some of the operations covered therein are to be considered optional, as will become evident in the following. FIGS. 7a and 7b merely provide some example implementations for the more general concept discussed in connection with FIGS. 4 to 6.

FIG. 7a shows a flow chart of a first more detailed example of the proposed workflow. The flow chart covers the entities UE 410 (i.e., the user equipment), gNB 420 (i.e., the target base station), WiFi AP 460 (providing the non-cellular communication channel), GW Function 471 (i.e., the gateway) and AMF 430 (i.e., the entity of the core network).

The flow starts with the registration request 710. According to this example, the UE starts the registration procedure by sending a NAS registration message 711 to the Non-3GPP AP (i.e., via the non-cellular communication channel), which forwards it to the GWF. At 712, the GWF reads the PLMN and selects the target AMF, e.g., by controlling the MCC/MNC (Mobile Country Code/Mobile Network Code) fields of the incoming message. Notably, the fields of the NAS registration message 711 (e.g., of the request for registering the user equipment to the cellular mobile communication system) can be extended to include the list of available cells from one or multiple RAN nodes (e.g., potential target base stations) which are in the proximity of the requesting UE. Alternatively, the cell list can be determined by other out-of-band mechanisms and announcement, for example derived from the UE's current or future location.

At 713, the GWF generates a RAN (Radio Access Network) UE NGAP (Next Generation Application Protocol) ID (Identifier) on behalf of the gNB. Such an ID is used in the RAN and core domain to keep track of the message exchange for the specific UE request. Such ID should not conflict with any other ID generated by the gNBs. A simple implementation avoiding this issue may comprise reserving a set of IDs for the GWF procedures. Other implementations are also possible.

The NGAP: Initial UE Message+Registration Request message 714 (i.e., the forwarded request for registering the user equipment to the cellular mobile communication system) is sent from the GWF on behalf of the gNB. NAS messages related to identification, authentication and security purposes 720 are exchanged between the UE and the mobile core exploiting the Non-3GPP (i.e., non-cellular communication channel) path. In particular, the AMF may send an NGAP NAS Identity request 721 to the GWF, which may forward the message as NAS Identity request 722 to UE, answered by the UE wit NAS Identity response 723, which is forwarded to AMF 430 as NGAP NAS Identity response 724. Similar procedures are performed with respect to (NGAP) NAS Authentication request/response (messages 725-728) and (NGAP) NAS Security Mode Command/Complete (messages 729-732). For example, these messages may be exchanged as part of the registration procedure 530 shown in FIG. 5.

The AMF may send an NGAP Initial Context Setup Request and Registration Accept 733 to the GWF after the above messages are exchanged. At 734, the GWF selects a target RAN node for the UE. Alternatively, the AMF 734 selects the target RAN node for the UE. Accordingly, the method of FIG. 6 may comprise selecting 630, by the gateway (GWF) or the entity (AMF) of the core network of the cellular mobile communication system, a target base station (target RAN node) the user equipment is to be connected to, based on the request for attaching a user equipment to the cellular mobile communication system. This operation can be the output of ad-hoc operator specific load balancing policies.

The target RAN node ID is shared 736a to the requesting UE. The RAN node is also informed 373a (via the AMF) and prepares 738 the UE context at RRC level. Accordingly, with respect to the method of FIG. 6, the method may comprises providing 640, by the entity of the core network of the cellular mobile communication system (e.g., the AMF), first information on the user equipment being registered to the cellular mobile communication system to a target base station the user equipment is to be connected to, and setting up 650, by the target base station, a user equipment context for the user equipment. For example, in this case, the first information on the user equipment being registered to the cellular mobile communication system may comprise the UE NGAP IDIn the example of FIG. 7b, the first information on the user equipment being registered to the cellular mobile communication system being provided to the gNB may comprise additional information, such as an UE context. Note that this last message exchange may be sent through an already established N2 endpoint. This is preferable as it avoids the setup of a dedicated interface between the GWF and the target gNB.

Upon DL and UL synchronization 740, 741 with the target RAN node, the UE performs standard message exchange procedure (UE capability exchange 732, UE AS security mode command 743, SRB (Signaling Radio Bearer) 2, DRB (Data Radio Bearer) 744, Registration Complete 745) to setup radio link security and prepare for the data exchange. It follows the setup of a PDU session 746 through a GTP tunnel, which involves the AMF and UPF. The message exchange (between UE and gNB) is performed through the 3GPP path. At this time the UE may benefit from a dedicated logical channel offered by the serving base station. It can also avoid performing the overall NAS procedure.

Notably, the UE may still perform the decoding of some RACH messages to achieve UL synchronization with the serving base station (mainly RACH msg1 and msg2). However, this activity can be performed regardless the actual load in the RAN domain.

FIG. 7b shows a flow chart of a second detailed example of the proposed workflow, providing an alternative or extension to the example of FIG. 7a. As depicted in the example of FIG. 7b, an alternative procedure which may provide further advantages implies the adoption of an existing non-3GPP access communication channel to transfer RACH/RRC parameters, UL/DL synchronization information, etc., towards the connecting UE, enabling to fully overcome the RACH procedure. This would be particularly useful in crowded scenarios which generally present high RACH collisions rate. This aspect is also indicated in the methods of FIGS. 5 and 6.

On the side of the cellular mobile communication system, shown in FIG. 6, this procedure may comprise providing, by the entity of the core network of the cellular mobile communication system e.g., the AMF, second information on the user equipment being registered to the cellular mobile communication system to the gateway (e.g., the GWF), to be received 660 by the gateway. The method may comprise forwarding 670, by the gateway, the second information on the user equipment being registered to the cellular mobile communication system to the user equipment via the non-cellular communication channel. The user equipment may use this information to support the registration procedure. On the side of the user equipment, as shown in FIG. 5, the method may comprise obtaining 540, from the entity of the cellular mobile communication system (e.g., the GWF) via the non-cellular communication channel, the second information on the user equipment being registered to the cellular mobile communication system. This second information on the user equipment being registered to the cellular mobile communication system may comprise useful information that facilitates performing the registration procedure. In particular, the second information on the user equipment being registered to the cellular mobile communication system may comprise at least one of information on a target base station the user equipment is to be connected to, RACH, parameter information, RRC parameter information, uplink/downlink synchronization information, and a Cell-Random Temporary Network Identifier, C-RTNI. The user equipment may then connect 550 to the target base station based on the information on the user equipment being registered to the cellular mobile communication system, e.g., by using the obtained RACH parameters, RRC parameters, UL/DL synchronization information, and/or C-RTNI to facilitate the procedure.

In particular, in contrast to the example of FIG. 7a, at 735, UE identification parameters such as the Cell-Random Temporary Network Identifier (C-RTNI) can be derived by the target gNB or generated externally, e.g., by the GW function or AMF, and transferred by means of control messages 736b, 737b, replacing messages 736a and 737a, involving existing interfaces to the target gNB, and by means of a Non-3GPP communication channel towards the UE. In this way, a connecting UE would be able to obtain all the required parameters necessary to synchronize in both uplink and downlink direction with the target gNB, which in turn would schedule transmission opportunities exploiting the information contained in the obtained UE context.

In the following, a first use case is introduced that deals with a congested 3GPP shared medium. In these examples, a scenario is assumed in which the 3GPP shared access medium used during the RACH procedure is congested by a large number of attach requests performed by multiple UEs, like in the case of crowded environments.

For example, Stadium scenarios are well known to provide particularly harsh wireless channel conditions due to the multitude of people simultaneously trying to access the mobile network over a small set of radio base stations. For example, an empirical analysis of RAN KPIS based on real traces are available in L. Zanzi, V. Sciancalepore, A. Garcia-Saavedra, X. Costa-Perez, G. Agapiou, H. D. Schotten, ARENA: A Data-driven Radio Access Networks Analysis of Football Events, IEEE Transaction on Network Service and Management, 2020, doi: 10.1109/TNSM.2020.3032829, while the problem has been analytically studied by Paolo Castagno, Vincenzo Mancuso, Matteo Sereno, Marco Ajmone Marsan, Limitations and sidelink-based extensions of 3GPP cellular access protocols for very crowded environments, Computer Networks, Volume 168, 2020, which showcased that by means of coordinated access procedures performed in a device-to-device manner the number of successful RACH procedures can significantly increase.

In these settings, by exploiting the proposed concept, a UE can initiate the registration procedure by offloading its request to a nearby Non-3GPP access point (e.g., WiFi-based). The request can be collected by the Gateway Function, and forwarded to the 5G core following the operations depicted in FIGS. 4-7b, triggering the execution of NAS registration procedure independently of the 3GPP congestion at the RAN domain.

In the following, a second use case is introduced that deals with a registration procedure setup in non-proximity gNB. In this example, a different scenario is assumed in which the UE may initiate a 3GPP registration procedure with a gNB that is not in located its proximity. In this context, the proposed concept enables to initiate the registration procedure on a generic target cell, the latter being identified from the network or UE perspective depending on the specific use-case.

For example, UEs traveling on planes may suffer long attachment requests time due to the simultaneous attachment trials of a large number of devices exiting their airplane mode state upon landing at the plane destination. Additionally, potential roaming procedures, e.g., authentication with the Home PLMN of the UEs, performed by the core network of the visited PLMN network can further enlarge the perceived delay.

We can assume the plane is equipped with multiple WLAN access points, as well as of a GW function connected to its Home PLMN core network. In this context, by adopting the proposed concept the UEs could benefit from an ‘early registration’ procedure with the visited PLMN network by sending their NAS registration procedure through the airline's GW function (which can be equivalently considered as trusted or untrusted) during their flight, well in advance with respect to their landing time.

In this example, load balancing procedures can be also considered by assuming the possibility to share with the airplane GW function the list of available Cell IDs in the proximity of the landing area. An exact and optimal mapping of requesting UE with a target Cell is going to dependent on multiple factors, including geographical ones like the set of available cells, as well as temporal ones like busy times which may increase the current load from UEs camping in the near Terminals, etc.

Embodiments of the proposed concept may comprise one or more of the following aspects.

For example, the UE may initiate a 3GPP NAS procedure through Non-3GPP GW function. Selected or list of suitable cells may be provided.

For example, the GW function may perform a NGAP procedure on an N2 reference point towards the selected AMF on behalf of the gNB that supports the selected cell. The GW function may perform cell list and cell selection, Cell-to-RANnode (gNB) mapping (resulting target gNB where the UE will proceed with RRC procedure and connection establishment) and/or AMF selection per the relevant target gNB.

For example, the GW function may assign an RAN NGAP UE ID to the UE context. The selected ID does not collide with IDs being managed and assigned by the target gNB. For example, separate blocks of IDs, coordination between GW function and target gNB, etc. may be used. The GW function may receive AMF NGAP UE ID from the AMF. The GW may perform NGAP procedure with the AMF in support of the UE's NAS procedure.

The NGAP context may be transferred from the GW function to the target RAN node/gNB. For example, this may be done via a N2 reference point and via AMF, or via dedicated reference point between GW function and target RAN node/gNB. The AMF may transfer subsequent NGAP procedures for the associated RAN NGAP UE ID and AMF NGAP UE ID to the target RAN node/gNB.

The GW function may release context for the transferred UE context (RAN NGAP UE ID/AMF NGAP UE ID). The GW function may become aware of when the target RAN node/gNB releases the RAN NGAP UE ID.

In an alternative RAN NGAP UE ID treatment, after transfer of NGAP context from GW function to target RAN node/gNB, the target RAN node/gNB may update the RAN NGAP UE ID without breaking the NGAP session with the AMF. AMF and target RAN node/gNB may support RAN NGAP UE ID update during NGAP context transfer between GW function and target RAN node/gNB. This procedure may avoid the need for alignment and coordination of RAN NGAP UE ID blocks between the GW function and potential target RAN nodes/gNBs.

The following assumptions may apply: The overload applies to the shared channels in 3GPP access while sufficient resources are available in the 5G core and the target RAN node/gNB to serve additional UEs by processing their signaling and to provide the requested bearers. The use of non-3GPP access as backdoor/fallback per the proposed concept is feasible for the respective UE without a previously established 3GPP connection. The use of non-3GPP access as backdoor/fallback per the proposed concept is feasible for the respective UE without a completed attachment and connection establishment in the non-3GPP access. Completed operations for accessing the 5G core though non-3GPP access and the associated GW function is assumed.

A variant of the fallback scenario addresses a UE that has a connection established through non-3GPP access already, with or without resources being assigned to that connection. The UE may want to make use of the existing non-3GPP connection to start the NAS procedure, that applies to the 3GPP access, per the proposed concept for a later connection establishment through 3GPP access. This can be used to accelerate the later completion of the 3GPP connection setup in case the UE is not yet in the proximity of potential 3GPP access cells.

A further variant of the fallback scenario that overcomes the RACH procedure and the UE's dependency on available RACH resources completely by the delivery of UE identification parameters such as Cell-Random Temporary Network Identifier (C-RTNI) from control messages involving existing interfaces to the target gNB, and by means of a non-3GPP communication channel towards the UE.

Embodiments of the present disclosure provide methods and systems for increasing the success rate and decreasing the latency for a completed attachment and connection establishment procedure for 3GPP access in a crowded or heavily loaded environment, the methods/systems comprising one or more of the following steps/components. For example, the methods/components may comprise a non-3GPP access Gateway function that receives an extended NAS registration message from a UE which comprises information about target 3GPP access node to which the NAS procedure applies. For example, the system or methos may use a non-3GPP access Gateway function that performs the NGAP operation with the 5G core network in support of the UE's NAS procedure with a selected AMF on behalf of a target RAN node/gNB. For example, the system or methos may use the non-3GPP access Gateway function and the AMF supporting the transfer of the UE's NGAP association to the target RAN node/gNB after the UE's completed RRC procedure with the target RAN node/gNB. For example, the system or methos may use the UE completing attachment and connection establishment through the target RAN node/gNB.

The proposed concept may use anon-3GPP access as fallback to perform the NAS procedure with the 5G core for later use of 3GPP access. The proposed concept may advance a UE's attachment for 3GPP access connection establishment without dependency on a completed 3GPP access RRC procedure. The proposed concept may accelerate a successful attach and connection establishment procedure for 3GPP access in crowded and loaded environments. The proposed concept may mitigate RACH congestion in crowded scenarios. It may provide an alternative registration option for 3GPP or other cellular networks.

Many modifications and other embodiments of the disclosure set forth herein will come to mind to the one skilled in the art to which the disclosure pertains having the benefit of the teachings presented in the foregoing description and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

While subject matter of the present disclosure has been illustrated and described in detail in the drawings and foregoing description, such illustration and description are to be considered illustrative or exemplary and not restrictive. Any statement made herein characterizing the invention or the disclosure is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

310, 410 User equipment
311, 411 5G transceiver
312, 412 WiFi transceiver
320, 420 Base station
330, 430 Access and Mobility Management Function, AMF
340, 440 Session Management Function, SMF
350, 450 Network Slice Selection Function, NSSF
351, 451 NF Repository Function, NRF
352, 452 Authentication Service Function, AUSF
353, 354 Unified Data Management, UDM
354, 454 Policy Control Function, PCF
355, 455 Application Function, AF
360, 460 WiFi access point
370 Gateway function
371, 471 Non-3GPP Inter Working Function, N3IWF
372 Trusted WLAN Interworking Function, TWIF
373 Trusted Non-3GPP Gateway Function, TNGF
380, 480 User Plane Function, UPF
390, 490 Data network
510 Attempting RACH procedure
520 Providing a request for registering UE to cellular mobile communication system
530 Performing the registration procedure
540 Obtaining information on the user equipment being registered to the cellular mobile communication system
550 Connecting to a target base station
610 Obtaining a request for registering UE to cellular mobile communication system
620 Forwarding the request to a core network entity
630 Selecting a target base station
640 Providing first information on the user equipment being registered to the cellular mobile communication system to the target base station
650 Setting up user equipment context
660 Receiving second information on the user equipment being registered to the cellular mobile communication system
670 Forwarding the second information to the UE
710 Registration request
711 NAS registration message
712 GWF selects target AMF
713 GWF generates Radio Access Network User Equipment Next Generation Application Protocol Identifier, RAN UE NGAP ID
714 NGAP Initial UE Message+Registration Request message
720-732 NAS messages related to identification, authentication and security purposes
733 NGAP Initial Context Setup Request and Registration Accept message
734 GWF selects target RAN node (target base station)
735 Determine UE Context, e.g., C-RTNI, RAN UE NGAP ID, etc.
736a Inform UE About target RAN Node ID
736b Inform UE About target RAN Node ID+C-RTNI
737a Inform RAN Node+UE NGAP ID
737b Inform RAN Node+UE Context
740 DL synchronization
741 UL synchronization
742 UE capability exchange
743 AS security mode command
744 SDR2, DRB
745 Registration complete
746 PDU session

1. A method performed by a user equipment, the method comprising:
providing, to an entity of a cellular mobile communication system, a request for registering the user equipment to the cellular mobile communication system, via a non-cellular communication channel; and
performing a registration procedure for connecting the user equipment to the cellular mobile communication system, based on the request.

2. The method according to claim 1, wherein the request is provided via the non-cellular communication channel after an unsuccessful attempt of gaining access to a shared channel of the cellular mobile communication system.

3. The method according to claim 1, wherein the request is provided to a gateway of the cellular mobile communication system for providing access to a core network of the cellular mobile communication system via non-cellular communication channels.

4. The method according to claim 1, wherein the request is provided, via a wireless communication channel being based on a communication protocol of the group of IEEE 802.11-based communication protocols.

5. The method according to claim 1, wherein the request includes a Non-Access Stratum (NAS) registration message.

6. The method according to claim 1, further comprising:
obtaining, from the entity of the cellular mobile communication system via the non-cellular communication channel, information on the user equipment being registered to the cellular mobile communication system with at least one of:
information on a target base station the user equipment is to be connected to,
Random Access Channel (RACH) parameter information,
Radio Resource Control (RRC) parameter information,
uplink/downlink synchronization information, and
a Cell-Random Temporary Network Identifier (C-RTNI), and
connecting to the target base station based on the information on the user equipment being registered to the cellular mobile communication system.

7. A method performed by a gateway of a cellular mobile communication system, the method comprising:
obtaining, a request for registering a user equipment to the cellular mobile communication system, wherein the request has initially been transmitted by the user equipment via a non-cellular communication channel; and
forwarding the request to an entity of a core network of the cellular mobile communication system.

8. The method according to claim 7, wherein the request is forwarded to the entity of the core network on behalf of a target base station the user equipment is to be connected to.

9. The method according to claim 7, further comprising:
receiving, from the entity of the core network of the cellular mobile communication system, second information on the user equipment being registered to the cellular mobile communication system; and
forwarding the second information on the user equipment being registered to the cellular mobile communication system to the user equipment via the non-cellular communication channel.

10. The method according to claim 9, wherein the second information comprises at least one of:
information on a target base station the user equipment is to be connected to,
Random Access Channel (RACH) parameter information,
Radio Resource Control (RRC) parameter information,
uplink/downlink synchronization information, and
a Cell-Random Temporary Network Identifier, (C-RTNI).

11. The method according to claim 7, wherein a target base station the user equipment is to be connected to is selected by one of the gateway and the entity of the core network of the cellular mobile communication system, based on the request.

12. The method according to claim 7, wherein
first information on the user equipment being registered to the cellular mobile communication system is provided from the entity of the core network node of the cellular mobile communication system to a target base station which the user equipment is to be connected to, and
a user equipment context for the user equipment is set up by the target base station.

13. A user equipment being configured to perform the method according to claim 1.

14. A gateway being configured to perform the method according to claim 7.

15. A cellular mobile communication system comprising a gateway and a core network with at least one core network entity, being configured to perform the method according to claim 7.
